(19) United States
(12) Patent Application Publication
(10) Pub. No.: US 2006/0016295 A1
(43) Pub. Date: Jan. 26, 2006

(54) Wrench having greater torque

(76) Inventor: Chih-Ching Hsien, Taichung (TW)

Correspondence Address: Chih-Ching Hsien, 23 Chung-Ho, Box 8-4, Taichung, TW

(21) Appl. No.: 11/234,810

(22) Filed: Sep. 26, 2005

Related U.S. Application Data
(63) Continuation-in-part of application No. 10/684,156, filed on Oct. 9, 2003.

(51) Int. Cl. B25B 13/46

(52) U.S. Cl. 81/59.1

(57) ABSTRACT

A wrench capable of transferring power effectively comprise a wrench body having an end formed with a driving portion; the driving portion being formed with a receiving portion; a ratchet wheel being mounted in the receiving portion of the driving portion and having a periphery formed with a plurality of oblique concave portions; a plurality of rollers movably mounted in the oblique concave portions. When the roller is at a position where one side of the roller is in contact with a periphery of the driving portion and one side of he roller is in contact with a long side of the oblique concave portions, a line tangent to the periphery of the driving portion and passing through the contact point of the roller and the driving portion is inclined to the long side of the oblique concave portions with an angle preferably between 5 degrees to 30 degrees.

The present invention is a continuation in part of U.S. patent Ser. No. 10/684,156 assigned to and invented by the inventor of the present invention. Thus the contents of the U.S. patent Ser. No. 10/684,156 is incorporated into the present invention as a part of the specification of the present invention.

### BACKGROUND OF THE INVENTION

1. Field of the Invention

The present invention relates to a wrench, and more particularly to a wrench having a greater torque.

2. Description of the Related Art

A conventional wrench in accordance with the prior art shown in FIG. 4 comprises a wrench body 10 having an end formed with a round driving portion 11. A center of the driving portion 11 is formed with a round receiving portion 12. A round ratchet wheel 13 is mounted in the receiving portion 12 of the driving portion 11 and has a periphery formed with a plurality of oblique concave portions 14, and each of a plurality of rollers 15 is movably mounted in a respective one of the oblique concave portions 14 of the ratchet wheel 13 and each roller is urged by a wall of the receiving portion 12 of the driving portion 11. Each of the oblique concave portions 14 of the ratchet wheel 13 has a first end formed with a deeper concave portion 141 and a second end formed with a shallower concave portion 142.

Referring to FIGS. 4, 5 and 6, in the prior art, each oblique concave portion 14 has two sides, a long side and a short side. In the prior art, when the roller 15 is at a position where one side of the roller 15 is in contact with a periphery of the driving portion 11 and one side of he roller 15 is in contact with a long side of the oblique concave portions 14, a line C tangent to the periphery of the driving portion 11 and passing through the contact point of the roller 15 and the driving portion 11 is parallel to a line D passing through the long side of the oblique concave portions 14.

The plurality of oblique concave portions 14 are not continuous, namely, two adjacent oblique concave portions 14 are spaced by a section 18 along a periphery of the ratchet wheel 13. Furthermore, the section 18 is not in contact with an inner wall of the driving portion 11.

In operation, when the driving portion 11 of the wrench body 10 is rotated in the normal direction, each of the rollers 15 is rolled into the shallower concave portion 142 of a respective one of the oblique concave portions 14 of the ratchet wheel 13 and is urged on the wall of the receiving portion 12 of the driving portion 11, so that the ratchet wheel 13 is combined with the driving portion 11 of the wrench body 10 to rotate therewith. Thus, the ratchet wheel 13 is rotated by rotation of the driving portion 11 of the wrench body 10 so as to rotate a screw member (not shown) mounted in the ratchet wheel 13.

Alternatively, when the driving portion 11 of the wrench body 10 is rotated along a reverse direction, each of the rollers 15 is rolled into the deeper concave portion 141 of a respective one of the oblique concave portions 14 of the ratchet wheel 13 and is detached from the wall of the receiving portion 12 of the driving portion 11, so that the ratchet wheel 13 is detached from the driving portion 11 of the wrench body 10. Thus, the driving portion 11 of the wrench body 10 idles in the reverse direction.

The defect of the prior art is that since the long side of the oblique concave portions 14 is parallel to the line C, see FIG. 4, the roller 15 is possible to roll to one of the two sides, a left side and a right side in FIG. 4, so that the roller 15 is at an unstable position. Furthermore, the section 18 is not in contact with the side of the driving portion 11. Thus, the ratchet wheel 13 cannot tightly resist against the inner wall of the driving portion 11. Thus the force from the handle cannot be effectively transferred to the ratchet wheel 13 through the driving portion 11 to drive a screw unit.

### SUMMARY OF THE INVENTION

The primary objective of the present invention is to provide a wrench having a greater torque.

Another objective of the present invention is to provide a wrench, wherein the resultant driving force of the wrench passes through the ratchet wheel is greater, so that the wrench produces the maximum torque during operation.

A further objective of the present invention is to provide a wrench which produces the maximum torque during operation, thereby preventing the wrench from slipping from the screw member due to a smaller torque.

In accordance with the present invention, a wrench capable of transferring power effectively comprise a wrench body having an end formed with a driving portion; the driving portion being formed with a receiving portion; a ratchet wheel being mounted in the receiving portion of the driving portion and having a periphery formed with a plurality of oblique concave portions; a plurality of rollers each movably mounted in a respective one of the oblique concave portions of the ratchet wheel and each urged on a wall of the receiving portion of the driving portion; each of the oblique concave portions of the ratchet wheel having a first end formed with a deeper concave portion and a second end formed with a shallower concave portion. Each oblique concave portion has two sides, a long side and a short side. When the roller is at a position where one side of the roller is in contact with a periphery of the driving portion and one side of he roller is in contact with a long side of the oblique concave portions, a line A tangent to the periphery of the driving portion and passing through the contact point of the roller and the driving portion is inclined to the long side of the oblique concave portions. An angle is defined between the long side and a line passing the long side of the oblique concave portions, then the angle is between 5 degrees to 30 degrees.

### BRIEF DESCRIPTION OF THE DRAWINGS

FIG. 1 is a partially plan cross-sectional view of a wrench in accordance with the preferred embodiment of the present invention;

FIG. 2 is a plan view of a driving portion of the wrench as shown in FIG. 1;

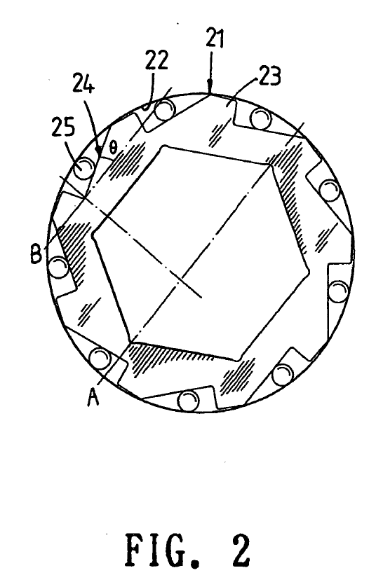

FIG. 3 is a locally plan view of the driving portion of the wrench as shown in FIG. 2;

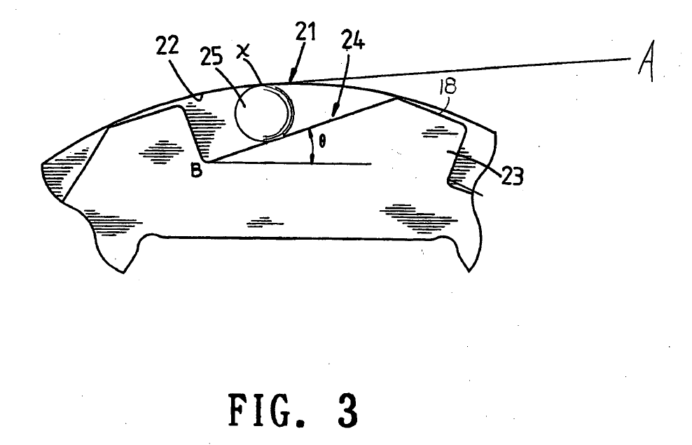

FIG. 4 is a partially plan cross-sectional view of a conventional wrench in accordance with the prior art;

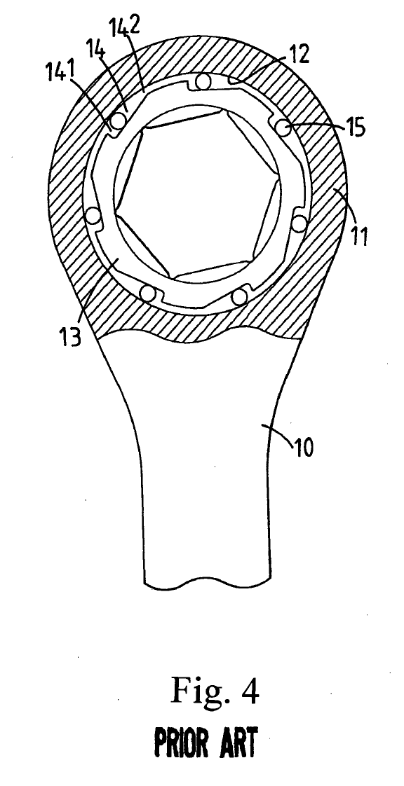

FIG. 5 is a plan view of a driving portion of the conventional wrench as shown in FIG. 5; and

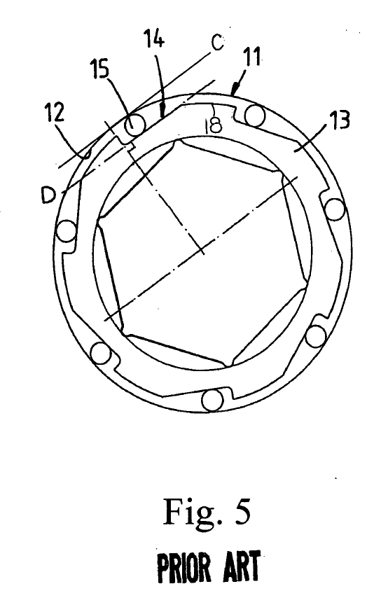

FIG. 6 is a locally plan view of the driving portion of the conventional wrench as shown in FIG. 5.

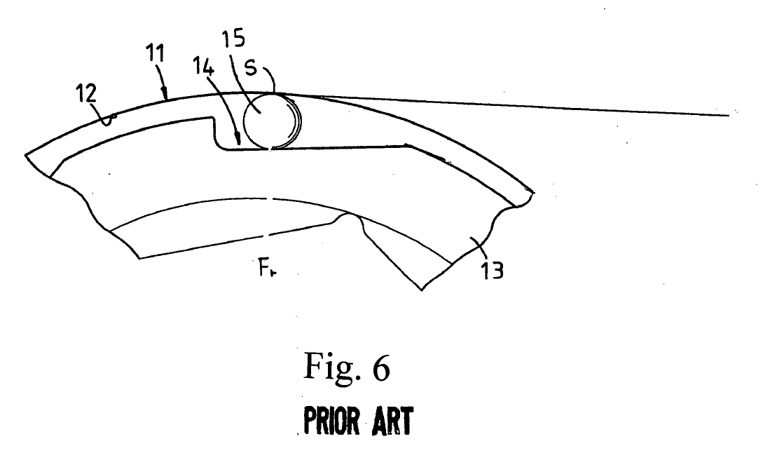

### DETAILED DESCRIPTION OF THE INVENTION

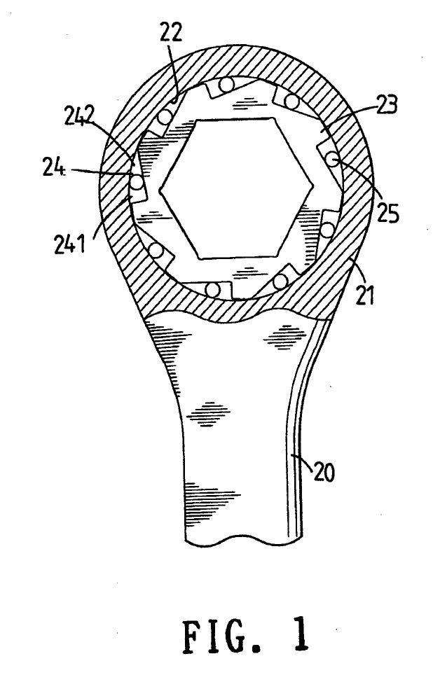

Referring to the drawings and initially to FIG. 1, a wrench in accordance with the preferred embodiment of the present invention comprises the following elements.

A wrench body 20 has one end formed with a driving portion 21. The driving portion 21 is formed with a receiving portion 22. A ratchet wheel 23 is mounted in the receiving portion 22 of the driving portion 21 and has a periphery formed with a plurality of oblique concave portions 24.

A plurality of rollers 25 is included and each is movably mounted in a respective one of the oblique concave portions 24 of the ratchet wheel 23 and urged on a wall of the receiving portion 22 of the driving portion 21. Each of the oblique concave portions 24 of the ratchet wheel 23 has a first end formed with a deeper concave portion 241 and a second end formed with a shallower concave portion 242.

Each oblique concave portion 24 has two sides, a long side and a short side. When the roller 25 is at a position where one side of the roller 25 is in contact with a periphery of the driving portion 21 and one side of the roller 25 is in contact with a long side of the oblique concave portions 24, a line A is tangent to the periphery of the driving portion 21 and passing through the contact point of the roller 25 and the driving portion 21. The line A is inclined to the long side of the oblique concave portions 24. An angle θ is defined between the long side and a line B passing the long side of the oblique concave portions 24. In the present invention, it is preferable, that the angle θ is between 5 degrees to 30 degrees.

Furthermore, a periphery point at a periphery of the ratchet wheel 23 between two adjacent oblique concave portions 24 is in contact to an inner wall of the driving portion 21.

Advantages of the present invention is that when the ratchet wheel 23 is tightly engaged to the driving portion 11, the roller 25 tightly resists against the wall of the driving portion 21. When driving a screw unit (not shown), the ratchet wheel 23 rotates counterclockwise, so that the roller 25 is driven to be more tightly clamped by the long sides of the oblique concave portion 24 and the inner wall of the driving portion 21. Moreover since a periphery point at a periphery of the ratchet wheel 23 between two adjacent oblique concave portions 24 is in contact to an inner wall of the driving portion 21, the driving portion 21 provides a friction force to the ratchet wheel 23. Thereby the force from the handle can be effectively transferred to the ratchet wheel 23 through the driving portion 21 so as to drive a screw effectively.

In operation, when the driving portion 21 of the wrench body 20 is rotated in the normal direction, each of the rollers 25 is rolled into the shallower concave portion 242 of a respective one of the oblique concave portions 24 of the ratchet wheel 23 and is urged on the wall of the receiving portion 22 of the driving portion 21, so that the ratchet wheel 23 is combined with the driving portion 21 of the wrench body 20 to rotate therewith. Thus, the ratchet wheel 23 is rotated by rotation of the driving portion 21 of the wrench body 20 so as to rotate a screw member (not shown) mounted in the ratchet wheel 23.

Alternatively, when the driving portion 21 of the wrench body 20 is rotated in the reverse direction, each of the rollers 25 is rolled into the deeper concave portion 241 of a respective one of the oblique concave portions 24 of the ratchet wheel 23 and is detached from the wall of the receiving portion 22 of the driving portion 21, so that the ratchet wheel 23 is detached from the driving portion 21 of the wrench body 20. Thus, the driving portion 21 of the wrench body 20 idles in the reverse direction.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A wrench capable of transferring power effectively comprising:
a wrench body having an end formed with a driving portion; the driving portion being formed with a receiving portion; a ratchet wheel being mounted in the receiving portion of the driving portion and having a periphery formed with a plurality of oblique concave portions;
a plurality of rollers; each roller being movably mounted in a respective one of the oblique concave portions of the ratchet wheel and being urged on a wall of the receiving portion of the driving portion; each of the oblique concave portions of the ratchet wheel having a first end formed with a deeper concave portion and a second end formed with a shallower concave portion;
wherein each oblique concave portion has two sides, a long side and a short side; when the roller is at a position where one side of the roller is in contact with a periphery of the driving portion and one side of he roller is in contact with a long side of the oblique concave portions, a line A tangent to the periphery of the driving portion and passing through the contact point of the roller and the driving portion is inclined to the long side of the oblique concave portions.

2. The wrench capable of transferring power effectively as claimed in claim 1, wherein an angle is defined between the long side and a line passing the long side of the oblique concave portions and parallel to the line A, then the angle is between 5 degrees to 30 degrees.

3. The wrench capable of transferring power effectively as claimed in claim 1, wherein a periphery point at a periphery of the ratchet wheel between two adjacent oblique concave portions is in contact to an inner wall of the driving portion.
